(19) United States
(12) Patent Application Publication
(10) Pub. No.: US 2024/0380047 A1
(43) Pub. Date: Nov. 14, 2024

(54) BATTERY PACK

(71) Applicant: Prime Planet Energy & Solutions, Inc., Tokyo (JP)

(72) Inventor: Shinobu TERAUCHI, Kasai-shi (JP)

(21) Appl. No.: 18/641,436

(22) Filed: Apr. 22, 2024

(30) Foreign Application Priority Data
May 12, 2023 (JP) 2023-079212

(51) Int. Cl. H01M 50/242; H01M 50/209; H01M 50/224; H01M 50/249; H01M 50/264; H01M 50/289

(52) U.S. Cl. CPC H01M 50/242; H01M 50/209; H01M 50/224; H01M 50/264; H01M 50/289; H01M 50/249

(57) ABSTRACT

A battery pack includes a plurality of battery modules, and a case body forming a space where the plurality of battery modules are housed. The case body includes a bottom portion, a side portion erected from the bottom portion and surrounding the space, a boss portion joined to the side portion outside of the space and used to fasten the case body, and a rib portion extending between the plurality of battery modules adjacent to each other and joined to the side portion in the space. The boss portion and the rib portion are opposite to each other with the side portion interposed therebetween.

### CROSS REFERENCE TO RELATED APPLICATIONS

This nonprovisional application is based on Japanese Patent Application No. 2023-079212 filed on May 12, 2023 with the Japan Patent Office, the entire contents of which are hereby incorporated by reference.

### BACKGROUND OF THE INVENTION

### Field of the Invention

The present invention relates to a battery pack.

### Description of the Background Art

In Japanese Patent Laying-Open No. 2020-035554, for example, a battery pack is disclosed that includes a battery for driving an electric vehicle, and a battery case housing the battery. The battery case includes a case bottom wall, a case front wall, a case rear wall, and left and right case side walls. The case front wall, the case rear wall, and the left and right case side walls stand upward from the outer periphery of the case bottom wall. The battery case further includes a cross member constituted of an assembly of a large number of ribs, which stand upward from the case bottom wall, and joining the left and right case side walls. Cylindrical fixing portions are provided on the outer surfaces of the left and right case side walls in the vehicle width direction.

### SUMMARY OF THE INVENTION

In the battery pack disclosed in above-mentioned Japanese Patent Laying-Open No. 2020-035554, the battery case is fixed on the lower surface of a vehicle body floor using bolts inserted in the cylindrical fixing portions. In the case of such a battery pack, an excessive load is applied to the battery case via the cylindrical fixing portions with abrupt acceleration or deceleration, or sharp turning of the vehicle. Thus, a battery case is required to have high rigidity sufficient to withstand such a load.

It is therefore an object of the present invention to solve the above-described problem and provide a battery pack that enables increase in the rigidity of a case body.

[1] A battery pack comprising: a plurality of battery modules; and a case body forming a space where the plurality of battery modules are housed, wherein the case body includes a bottom portion, a side portion erected from the bottom portion and surrounding the space, a boss portion joined to the side portion outside of the space and used to fasten the case body, and a rib portion extending between the plurality of battery modules adjacent to each other and joined to the side portion in the space, and the boss portion and the rib portion are opposite to each other with the side portion interposed therebetween.

In the battery pack with such a structure, the boss portion and the rib portion are respectively joined to the side portion from the outer side and inner side of the space where the plurality of battery modules are housed, and the boss portion and the rib portion are disposed opposite to each other with the side portion interposed therebetween. Such a structure enables it to attain the case body that exhibits high rigidity even when an excessive load is applied to the case body via the boss portion used to fasten the case body.

[2] The battery pack according to [1], wherein when seen in a plan view, the bottom portion has a rectangular shape, the side portion is erected from a peripheral edge portion of the bottom portion, and the case body includes a plurality of the rib portions that, when the bottom portion is seen in the plan view, extend in a lattice pattern in the space and are each joined to the side portion at an angle of 90°, and a plurality of the boss portions that are respectively opposite to the plurality of rib portions with the side portion interposed therebetween and each extend in a direction orthogonal to the bottom portion.

In the battery pack with such a structure, the plurality of boss portions are respectively disposed opposite to the plurality of rib portions, which are provided in a lattice pattern, with the side portion interposed therebetween. Accordingly, the rigidity of the case body can be further increased.

[3] The battery pack according to [1] or [2], wherein the case body is made of metal, and the bottom portion, the side portion, the boss portion, and the rib portion are formed so as to be integrated with each other.

In the battery pack with such a structure, the bottom portion, the side portion, the boss portion, and the rib portion are formed of metal so as to be integrated with each other. Accordingly, the rigidity of the case body can be further increased.

The foregoing and other objects, features, aspects, and advantages of the present disclosure will become apparent from the following detailed description on the present invention, which will be understood in conjunction with the accompanying drawings.

### BRIEF DESCRIPTION OF THE DRAWINGS

FIG. 1 is an exploded view that illustrates a battery pack according to an embodiment of the present invention.

FIG. 2 is a cross sectional view that illustrates the battery pack viewed in a direction along a line II-II in FIG. 1.

FIG. 3 is a cross sectional view that illustrates the battery pack viewed in a direction along a line III-III in FIG. 1.

FIG. 4 is a top view that illustrates the range defined by a chain double-dashed line IV in FIG. 1 on an enlarged scale.

FIG. 5 is a top view that illustrates a first variation of a case body in FIG. 1.

FIG. 6 is a cross sectional view that illustrates a second variation of the case body in FIG. 1.

### DESCRIPTION OF THE PREFERRED EMBODIMENTS

Embodiments of the present invention are described with reference to the drawings. In the drawings referred to below, the same or corresponding members are denoted by the same reference characters.

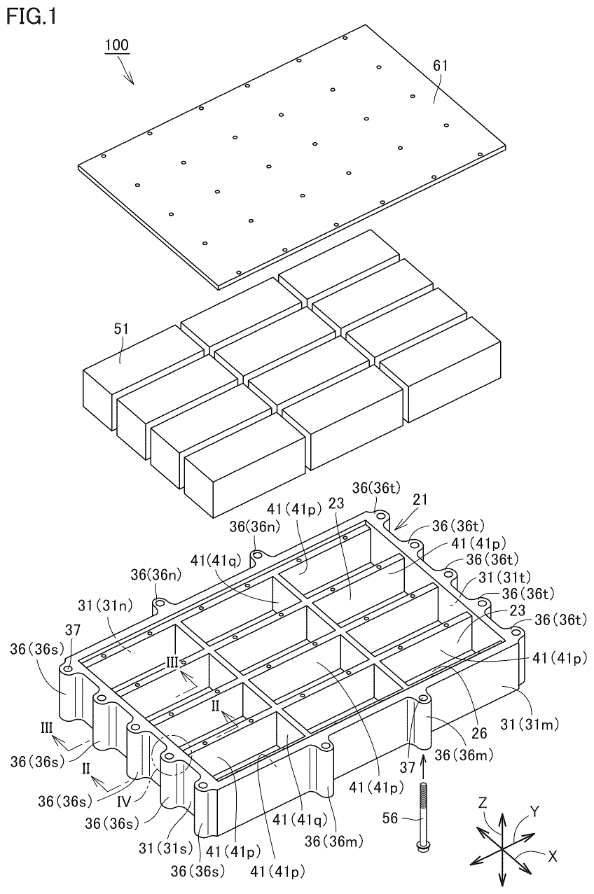

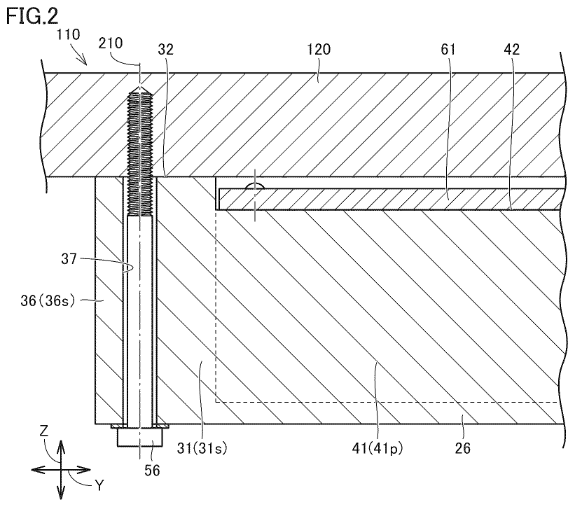

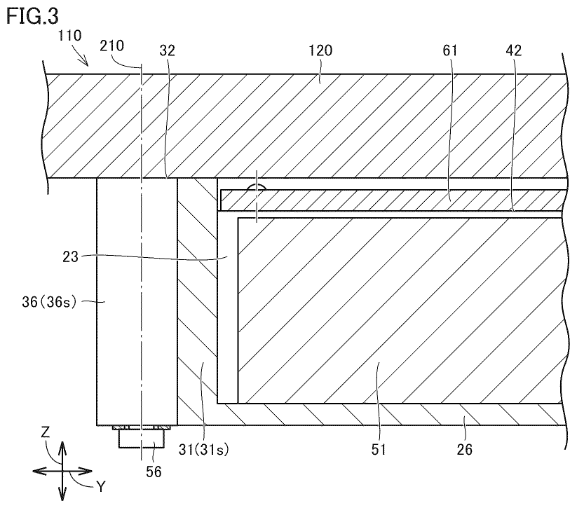

FIG. 1 is an exploded view that illustrates a battery pack 100 according to an embodiment of the present invention. FIG. 2 is a cross sectional view that illustrates battery pack 100 viewed in a direction along a line II-II in FIG. 1. FIG. 3 is a cross sectional view that illustrates battery pack 100 viewed in a direction along a line III-III in FIG. 1.

Referring to FIGS. 1 to 3, battery pack 100 is mounted on a vehicle 110, such as a hybrid electric vehicle (HEV), a plug-in hybrid electric vehicle (PHEV), or a battery electric vehicle (BEV). Battery pack 100 is used as a power source for driving vehicle 110.

Battery pack 100 includes a plurality of battery modules 51. Each battery module 51 is constituted of a plurality of battery cells (not illustrated) stacked in a single direction and electrically connected in series to each other. Each battery cell is constructed as a prismatic lithium ion battery.

Herein, for convenience in describing a structure of battery pack 100, a “Y axis” represents an axis corresponding to a direction in which the plurality of battery cells are stacked and extending in a horizontal direction, an “X axis” represents an axis extending in a direction orthogonal to the Y axis and in the horizontal direction, and a “Z axis” represents an axis extending in an up-and-down direction. Battery pack 100 is typically mounted on vehicle 110 so that one of the X axis direction and the Y axis direction corresponds to a fore-and-aft direction of vehicle 110 and the other of the X axis direction and the Y axis direction corresponds to a side-to-side direction of vehicle 110.

Battery pack 100 further includes a case body 21. Case body 21 is made of metal. Case body 21 is made of aluminum for example. As a whole, case body 21 is formed of a box body, which is open upward and has an external appearance with a rectangular parallelepiped shape. Case body 21 forms a space 23 where the plurality of battery modules 51 are housed. The plurality of battery modules 51 are arranged like a matrix in space 23 so as to be spaced from each other in both the X axis direction and the Y axis direction.

The plurality of battery modules 51 are not limited to the aforementioned matrix-like arrangement but may be arranged so as to be aligned in a single line in one of the X axis direction and the Y axis direction.

Battery pack 100 further includes a lid body 61. Lid body 61 is formed of a plate material having a thickness whose direction corresponds to the Z axis direction (the up-and-down direction) and disposed in parallel with an X-Y axes plane. Lid body 61 is provided so as to close an opening portion of case body 21. Lid body 61 is fastened to a plurality of rib portions 41, which are described below, using bolts (not illustrated).

Case body 21 includes a bottom portion 26 and a side portion 31. Bottom portion 26 has a shape of a wall having a thickness whose direction corresponds to the Z axis direction and disposed in parallel with an X-Y axes plane. In a plan view taken in the Z axis direction, bottom portion 26 has a rectangular shape. The plurality of battery modules 51 are placed on bottom portion 26.

Side portion 31 is erected from bottom portion 26 and surrounds space 23. In a plan view, side portion 31 is erected from a peripheral edge portion of bottom portion 26.

Side portion 31 includes a pair of a side portion 31s and a side portion 31t, and a pair of a side portion 31m and a side portion 31n. The pair of side portion 31s and side portion 31t are opposite to each other in the Y axis direction with space 23 interposed therebetween. Each side portion 31 of side portion 31s and side portion 31t has a shape of a wall having a thickness whose direction corresponds to the Y axis direction and disposed in parallel with an X-Z axes plane. The pair of side portion 31m and side portion 31n are opposite to each other in the X axis direction with space 23 interposed therebetween. Each side portion 31 of side portion 31m and side portion 31n has a shape of a wall having a thickness whose direction corresponds to the X axis direction and disposed in parallel with a Y-Z axes plane.

Case body 21 further includes rib portion 41. Rib portion 41 is provided in space 23. Rib portion 41 extends between the plurality of battery modules 51 adjacent to each other. Rib portion 41 is erected from bottom portion 26 and extends like a rib in a single direction parallel to the horizontal direction.

Case body 21 includes the plurality of rib portions 41. The plurality of rib portions 41 include a plurality of rib portions 41p and a plurality of rib portions 41q.

Rib portion 41p has a shape of a rib having a thickness whose direction corresponds to the X axis direction and extending in the Y axis direction. Rib portion 41p is joined to side portion 31s at one end portion of rib portion 41p extending in the Y axis direction and is joined to side portion 31t at the other end portion of rib portion 41p extending in the Y axis direction. Rib portion 41p is joined to each side portion 31 of side portion 31s and side portion 31t at an angle of 90°. The plurality of rib portions 41p are spaced from each other in the X axis direction. The plurality of rib portions 41p are arranged at regular intervals in the X axis direction. Rib portion 41p is disposed between the plurality of battery modules 51 adjacent to each other in the X axis direction.

Rib portion 41p included in the plurality of rib portions 41p and disposed at one end portion in the X axis direction extends along side portion 31m in the Y axis direction. Rib portion 41p included in the plurality of rib portions 41p and disposed at the other end portion in the X axis direction extends along side portion 31n in the Y axis direction.

Rib portion 41q has a shape of a rib having a thickness whose direction corresponds to the Y axis direction and extending in the X axis direction. Rib portion 41q is joined to side portion 31m at one end portion of rib portion 41q extending in the X axis direction and is joined to side portion 31n at the other end portion of rib portion 41q extending in the X axis direction. Rib portion 41q is joined to each side portion 31 of side portion 31m and side portion 31n at an angle of 90°. The plurality of rib portions 41q are spaced from each other in the Y axis direction. The plurality of rib portions 41q are arranged at regular intervals in the Y axis direction. Rib portion 41q is disposed between the plurality of battery modules 51 adjacent to each other in the Y axis direction.

The plurality of rib portions 41 extend in a lattice pattern in space 23. The plurality of rib portions 41p and the plurality of rib portions 41q intersect at an angle of 90°.

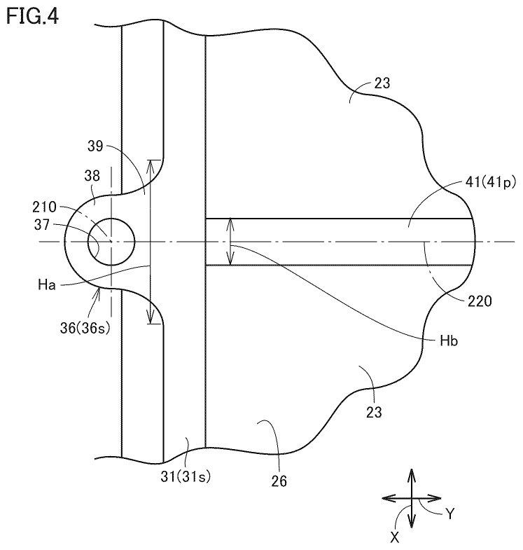

FIG. 4 is a top view that illustrates case body 21 in the range defined by a chain double-dashed line IV in FIG. 1. Hereinafter, a structure of case body 21 is described with reference to a boss portion 36s and rib portion 41p that are joined to side portion 31s in FIGS. 2 to 4. The positional correlation between a boss portion 36 and rib portion 41 is common to that relative to each side portion 31 of side portion 31s, side portion 31t, side portion 31m, and side portion 31n.

Referring to FIGS. 1 to 4, case body 21 further includes boss portion 36 used to fasten case body 21. Boss portion 36 is joined to side portion 31 outside of space 23.

Boss portion 36 projects from the outer surface of side portion 31, which is positioned outside of space 23. Boss portion 36 extends axially in the up-and-down direction. The length of boss portion 36 in the Z axis direction is the same as the length of side portion 31 in the Z axis direction.

As illustrated in FIGS. 2 and 3, a top surface 32 of side portion 31 and boss portion 36 and a top surface 42 of rib portion 41 form a level difference. Lid body 61 is disposed in a portion with the level difference formed by top surface 32 and top surface 42. The length of boss portion 36 in the Z axis direction is larger than the length of rib portion 41 in the Z axis direction.

Case body 21 includes a plurality of boss portions 36. The plurality of boss portions 36 include a plurality of boss portions 36s, a plurality of boss portions 36t, a plurality of boss portions 36m, and a plurality of boss portions 36n.

Boss portion 36s is joined to side portion 31s. The plurality of boss portions 36s are spaced from each other in the X axis direction. Boss portion 36t is joined to side portion 31t. The plurality of boss portions 36t are spaced from each other in the X axis direction. Boss portion 36m is joined to side portion 31m. The plurality of boss portions 36m are spaced from each other in the Y axis direction. Boss portion 36n is joined to side portion 31n. The plurality of boss portions 36n are spaced from each other in the Y axis direction.

As illustrated in FIGS. 2 and 3, case body 21 is fastened to a floor portion 120 of vehicle 110 via boss portion 36. A bolt insertion hole 37 is provided in boss portion 36. Bolt insertion hole 37 is formed of a through hole that passes through boss portion 36 in the Z axis direction. Case body 21 is assembled to vehicle 110 so that top surface 32 abuts on floor portion 120. A bolt 56 is inserted in bolt insertion hole 37 from the lower side of boss portion 36. Bolt 56 inserted in bolt insertion hole 37 is screwed into floor portion 120, and case body 21 is fastened to vehicle 110 accordingly.

As illustrated in FIG. 4, bolt insertion hole 37 has a shape of a circular opening centered around a central axis 210. Boss portion 36 (36s) includes a fastening portion 38 and a base portion 39. Fastening portion 38 corresponds to a portion where boss portion 36 (36s) is fastened to vehicle 110. Bolt insertion hole 37 is provided in fastening portion 38. Fastening portion 38 has a shape of a cylinder centered around central axis 210. Base portion 39 corresponds to a bottom part of boss portion 36 (36s) projecting from side portion 31 (31s). Base portion 39 is provided between side portion 31 (31s) and fastening portion 38.

Base portion 39 is provided so that the width of base portion 39 in the X axis direction becomes larger from central axis 210 toward side portion 31 (31s) in the Y axis direction. Base portion 39 may have a shape of constriction so that the width of base portion 39 in the X axis direction becomes smaller from central axis 210 toward side portion 31 (31s), and then becomes larger further toward side portion 31 (31s) in the Y axis direction.

Case body 21 is produced by metal die casting (aluminum die casting). Bottom portion 26, side portion 31, boss portion 36, and rib portion 41 are formed of metal so as to be integrated with each other.

As illustrated in FIGS. 1 and 4, boss portion 36 and rib portion 41 are opposite to each other with side portion 31 interposed therebetween. The plurality of boss portions 36s are respectively opposite to the plurality of rib portions 41p with side portion 31s interposed therebetween. The plurality of boss portions 36t are respectively opposite to the plurality of rib portions 41p with side portion 31t interposed therebetween. The plurality of boss portions 36m are respectively opposite to the plurality of rib portions 41q with side portion 31m interposed therebetween. The plurality of boss portions 36n are respectively opposite to the plurality of rib portions 41q with side portion 31n interposed therebetween.

As illustrated in FIG. 4, boss portion 36 (36s) is joined to side portion 31 (31s) in a first range Ha in the X axis direction. Rib portion 41 (41p) is joined to side portion 31 (31s) in a second range Hb in the X axis direction. First range Ha in the X axis direction is larger than second range Hb in the X axis direction. Boss portion 36 and rib portion 41 are provided so that part of first range Ha and all of second range Hb overlap each other. A center line 220 of rib portion 41 (41p), which divides second range Hb into halves in the X axis direction and extends in the Y axis direction, intersects central axis 210 of bolt insertion hole 37.

An excessive load is applied to case body 21 via boss portion 36 with abrupt acceleration or deceleration, or sharp turning of vehicle 110. In contrast, in the present embodiment, boss portion 36 and rib portion 41 are respectively joined to side portion 31 from the outer side and inner side of space 23 where the plurality of battery modules 51 are housed, and boss portion 36 and rib portion 41 are opposite to each other with side portion 31 interposed therebetween. This structure enables it to attain case body 21 that exhibits high rigidity against such a load.

For example, a case is assumed in which a load in the Y axis direction is applied to case body 21 in FIG. 1 via boss portion 36s. In this case, boss portion 36s, side portion 31s, rib portion 41p, side portion 31t, and boss portion 36t disposed in a Y-Z axes plane receive the load together and as a result, case body 21 can be prevented from deformation, breakage, or the like.

Additionally, since rib portion 41 has a role of partitioning space 23 where the plurality of battery modules 51 are housed and also has a function of increasing the rigidity of case body 21, it is enabled to reduce the size or weight of case body 21 and simplify the structure of case body 21.

Furthermore, in the present embodiment, the plurality of boss portions 36 are respectively disposed opposite to the plurality of rib portions 41, which are provided in a lattice pattern, with side portion 31 interposed therebetween. This structure further increases the rigidity of case body 21 and enables it to attain case body 21 that exhibits high rigidity against loads from various directions.

Moreover, in the present embodiment, bottom portion 26, side portion 31, boss portion 36, and rib portion 41 are formed of metal so as to be integrated with each other. Such a structure involves no interposition of welded portions among bottom portion 26, side portion 31, boss portion 36, and rib portion 41, and accordingly, the rigidity of case body 21 can be further increased. Also, airtightness of space 23 where the plurality of battery modules 51 are housed can be enhanced.

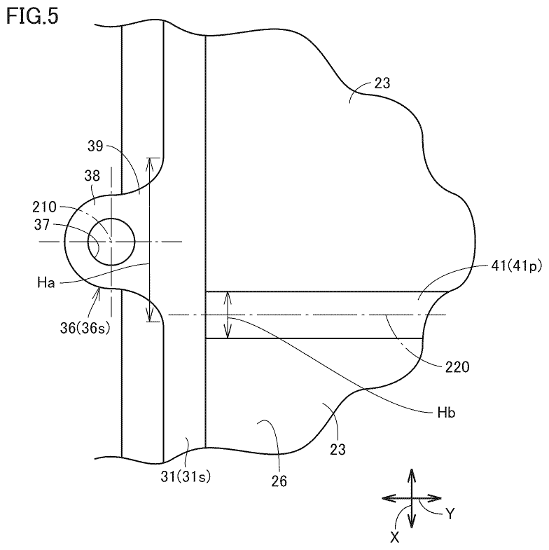

FIG. 5 is a top view that illustrates a first variation of case body 21 in FIG. 1. FIG. 5 corresponds to FIG. 4. Referring to FIG. 5, in the present variation, boss portion 36 and rib portion 41 are provided so that part of first range Ha and part of second range Hb overlap each other. Center line 220 of rib portion 41 (41p) and central axis 210 of bolt insertion hole 37 deviate from each other in the X axis direction.

When at least part of first range Ha and at least part of second range Hb overlap each other, boss portion 36 (36s) and rib portion 41 (41p) are opposite to each other with side portion 31 (31s) interposed therebetween.

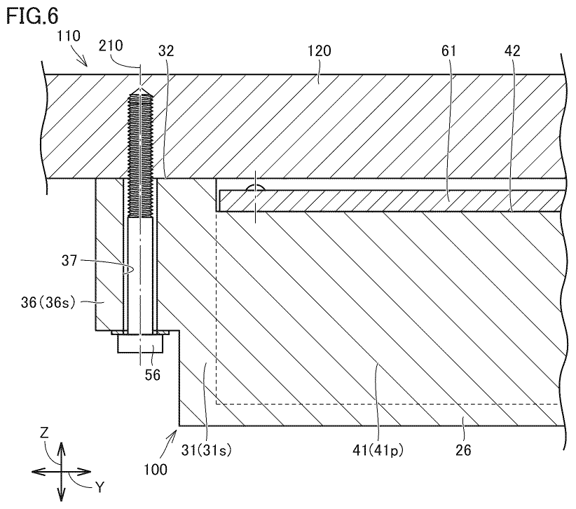

FIG. 6 is a cross sectional view that illustrates a second variation of case body 21 in FIG. 1. Referring to FIG. 6, in the present variation, the length of boss portion 36 in the Z axis direction is smaller than the length of rib portion 41 in the Z axis direction.

As exemplified in the present variation, the form of boss portion 36 used to fasten case body 21 to vehicle 110 is not particularly limited. For example, boss portion 36 and rib portion 41 may be structured so that top surface 32 and top surface 42 are coplanar. When cut along an X-Y axes plane, boss portion 36 may have a C-shaped cross section that allows insertion of a fastening means such as a bolt or the like.

Although embodiments of the present disclosure have been described, it should be understood that the herein-disclosed embodiments are presented by way of illustration and example in every respect and are not to be taken by way of limitation. The scope of the present disclosure is defined by the claims and intended to include all changes within the purport and scope equivalent to the claims.

What is claimed is:

1. A battery pack comprising:
a plurality of battery modules; and
a case body forming a space where the plurality of battery modules are housed, wherein
the case body includes
a bottom portion,
a side portion erected from the bottom portion and surrounding the space,
a boss portion joined to the side portion outside of the space and used to fasten the case body, and
a rib portion extending between the plurality of battery modules adjacent to each other and joined to the side portion in the space, and
the boss portion and the rib portion are opposite to each other with the side portion interposed therebetween.

2. The battery pack according to claim 1, wherein
when seen in a plan view, the bottom portion has a rectangular shape,
the side portion is erected from a peripheral edge portion of the bottom portion, and
the case body includes
a plurality of the rib portions that, when the bottom portion is seen in the plan view, extend in a lattice pattern in the space and are each joined to the side portion at an angle of 90°, and
a plurality of the boss portions that are respectively opposite to the plurality of rib portions with the side portion interposed therebetween and each extend in a direction orthogonal to the bottom portion.

3. The battery pack according to claim 1, wherein
the case body is made of metal, and
the bottom portion, the side portion, the boss portion, and the rib portion are formed so as to be integrated with each other.
